(19) United States
(12) Patent Application Publication
(10) Pub. No.: US 2002/0102949 A1
(43) Pub. Date: Aug. 1, 2002

(54) Remote control having an audio port

(76) Inventor: Sherman Langer, Maplewood, NJ (US)

Correspondence Address: Ian R. Blum, SKADDEN, ARPS, SLATE, MEAGHER & FLOM LLP, Four Times Square, New York, NY, 10036, US

(21) Appl. No.: 09/764,469

(22) Filed: Jan. 17, 2001

(51) Int. Cl. G08C 19/00; H04B 1/02; H04B 1/04

(52) U.S. Cl. 455/92; 340/825.69

(57) ABSTRACT

A remote control is disclosed having a set of input controls to control an electronic device, including a volume control, which are used for entering commands to control the electronic device. The commands are sent to the electronic device using a transmitter. The remote control includes an integral receiver capable of reproducing an audio signal received from the electronic device. The audio output is presented to a port for a headphone jack. When a headphone jack is inserted into the headphone port, the remote control transmits a mute command to the electronic device. Once a headphone jack is inserted into the port, the volume control is configured to control the audio output of the remote control.

### FIELD OF THE INVENTION

The present invention relates to remote control devices used for controlling electronic devices having an audio output. More particularly, the invention provides a remote control capable of muting the audio output of an electronic device and providing an audio output to a pair of headphones.

### BACKGROUND OF THE INVENTION

Use of remote control devices to control electronic devices is well known. Remote controls for televisions, radios, VCRs, DVD players, cable converters, multimedia computers, and stereo systems are available. Additionally, universal remote control devices are available. These universal remote control devices are able to control a variety of devices. For example, single remote controls are available to control a variety of electronic devices manufactured by different manufacturers. The user typically enters pre-programmed codes into the universal remote control to configure it to control the particular make and model of various electronic devices.

It is often desirable when listening to an electronic device such as a television or stereo system, to use headphones so as not to disturb others. Extension cords are available to extend the distance a user may be from the electronic device. While this allows a user to be away from the electronic device while still listening to the audio signal produced by the electronic device, the user is tethered to the electronic device by the headphone wire. One system has overcome the requirement of being tethered to the electronic device. The system uses an infra-red (IR) transmitter connected to the electronic device and a pair of headphones with an integral IR receiver that has volume and tone controls. In this manner, the user is able to listen to the stereo or watch television without being limited in movement by the length of the headphone wire. However, the user must use the headphone's volume and tone controls instead of the volume and tone control for the electronic device. Additionally, the volume control of the electronic device must be manually muted.

### BRIEF SUMMARY OF THE INVENTION

These and other limitations of the prior art are addressed in the present invention provides a remote control capable of both controlling at least one electronic device and providing an audio output. The remote control includes a set of input controls to control an electronic device. These input controls, including a volume control, are used for entering commands to control the electronic device. The commands are sent to the electronic device using a transmitter. Additionally, the volume control controls an amplifier in the remote control, which receives audio data from the electronic device and produces an audio output.

In one embodiment, the audio output is capable of being delayed to produce a surround sound effect. In this embodiment, the controls further are capable of varying the amount of the delay to modify the surround sound effect.

### BRIEF DESCRIPTION OF THE DRAWINGS

FIGS. 1A and 1B are orthogonal views of embodiments of a remote control having an audio output jack in accordance with the invention;

FIG. 2 is a block diagram of a remote control and an electronic device embodying one aspect of the invention; and

FIGS. 3 and 4 are diagrams of systems embodying the invention including a remote control and an electronic device capable of being controlled by the remote control.

### DETAILED DESCRIPTION OF THE INVENTION

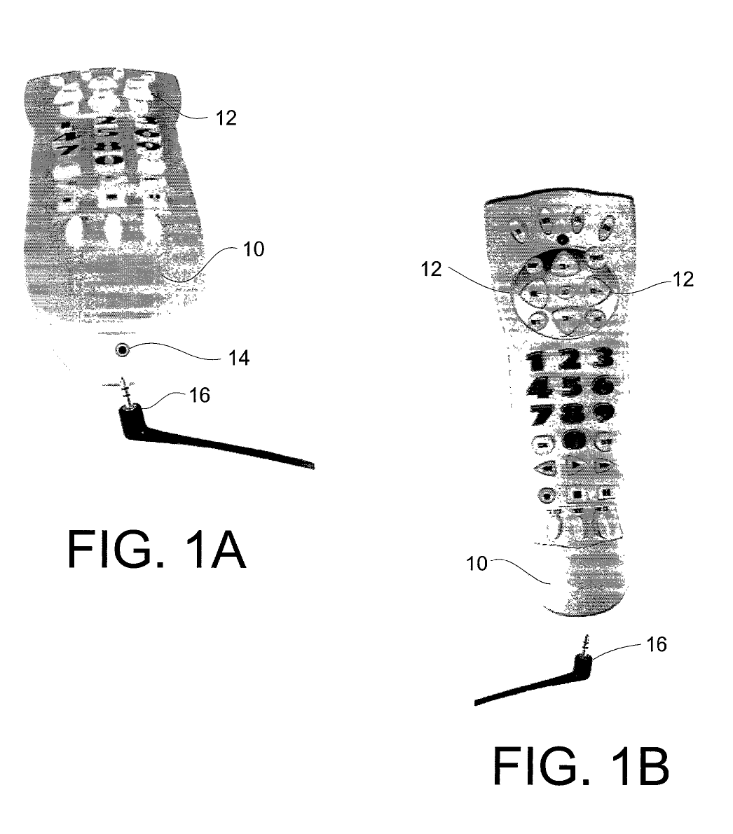

FIGS. 1A and 1B are orthogonal views of a remote control 10. Remote control 10 has a plurality of buttons used to enter commands to control an electronic device such as a television, radio, VCR, DVD player, CD player, multimedia computer, set-top box, cable converter, stereo system, and the like. In one embodiment, the remote control is a universal remote control, capable of being programmed to control multiple electronic devices. The remote control includes buttons 12 for controlling the volume or audio output level of the electronic device. While the remote is shown having buttons to enter commands, a touch pad, voice recognition circuitry, or the like may be used. The commands are transmitted to the electronic device in a wireless manner. The commands are transmitted using an IR transmitter, a radio-frequency transmitter, or the like. Additionally, the remote 10 has a port 14 for receiving a jack 16. Port 14 is used to drive a pair of headphones. Preferably, upon inserting a headphone jack 16 into port 14 the remote will automatically transmit a signal to mute the electronic device so that, in the case of a television, the user can view the video while listening to the audio through headphones. In one embodiment, a pair of speakers is plugged into the port 14 for a surround-sound effect.

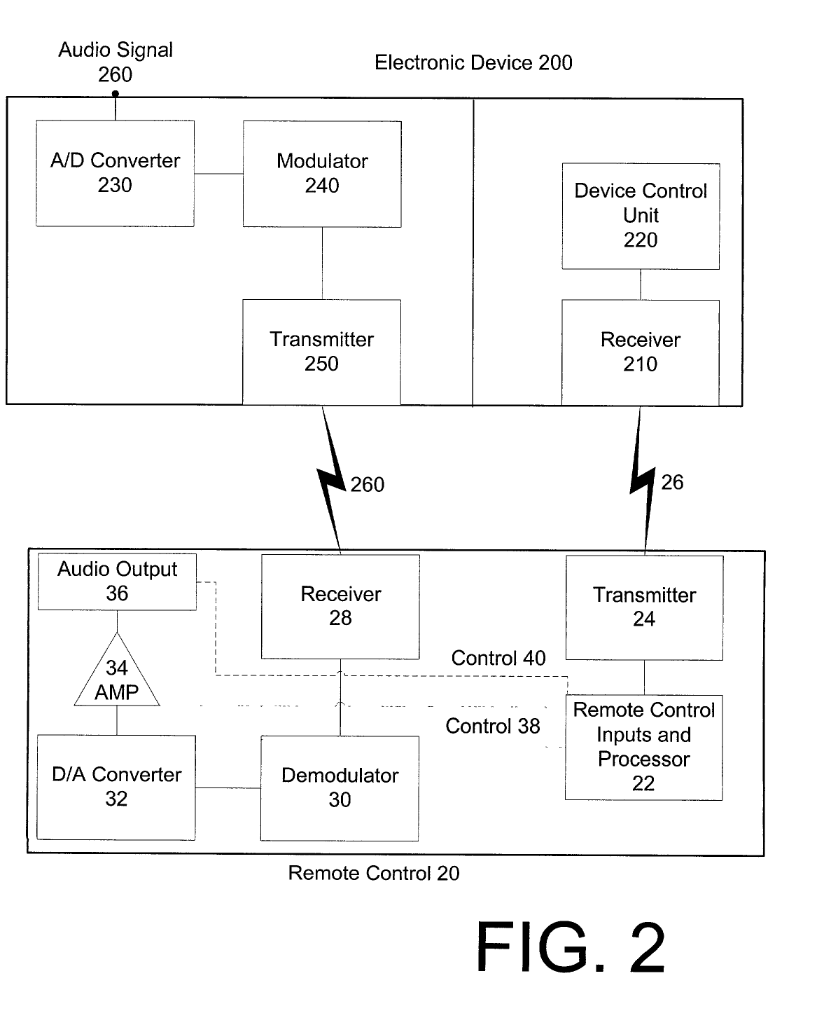

FIG. 2 is a block diagram of a preferred embodiment of a system containing a remote control 20 and an electronic device 200. The remote control has a set of inputs 22, such as buttons 12 (FIGS. 1A and 1B), which are used to designate commands for controlling the electronic device 200. Transmitter 24 is used to transmit the commands 26 to the electronic device. The transmitter is preferably an IR transmitter, a radio-frequency transmitter, or the like. A receiver 210 receives the commands. The receiver is connected to the electronic device's control unit 220. In many devices, the control unit 220 is a microprocessor. Control unit 220 sends commands to various parts of electronic device 200. For example, if electronic device 200 is a television, commands preferably include volume control and channel selection.

Electronic device 200 preferably includes an analog to digital (A/D) converter 230, a modulator 240, and a transmitter 250. Audio signal 260 is input to A/D converter 230. This audio signal is, in the case of a television, the audio component of a received television signal. In one embodiment, the audio signal is an audio output from another electronic device such as a radio or VCR. The audio signal is processed in the electronic device 200 first by A/D converter 230. Modulator 240 then modulates the output of the A/D converter. Modulator 240 modulates the digital audio signal using known modulation techniques such as amplitude modulation, frequency modulation, and the like. In one embodiment, a code key is added to the signal to prevent interference or bleedover into other electronic devices. A transmitter 250 sends the modulated signal to remote control 20. Transmitter 250 is preferably an IR transmitter, radio frequency transmitter, or the like. The transmitted signal 260 is received by remote control 20 in receiver 28. Receiver 28 is designed to receive the signals transmitted by transmitter 250. Therefore, receiver 28 is an IR receiver, radio frequency receiver, or the like. Demodulator 30 demodulates the received signal. The demodulated signal is then processed by digital to analog (D/A) converter 32. In one embodiment, the output of the D/A converter 32, the audio signal, is presented to the input of an amplifier 34. The amplifier 34 is controlled by the remote control inputs 22. The processed audio signal is then presented to an audio output 36 such as jack 14 of FIG. 1. In one embodiment, upon inserting a headphone jack 16 into port 14 the remote control will automatically transmit a signal to mute the electronic device so that, in the case of a television, the user can view the video while listening to the audio through headphones. In one embodiment, a single component is capable of performing both transmit and receive functions i.e., transmitter 250 and receiver 210 are a single component, and transmitter 24 and receiver 28 are a single component.

In one embodiment, a delay is added to the audio signal to create a delayed audio output that is used to drive a pair of rear surround sound speakers. In this manner, a user can create a home theatre without extensive wiring or additional electronic equipment. When used to create a delayed audio output, the remote control inputs 22 are used to vary the amount of the delay. In one embodiment, the delay is added to the audio signal in electronic device 200 prior to transmission to the remote control 20 by a delay module. In another embodiment, a delay module in the remote control 20 adds the delay after receiver 28 receives the transmitted signal. Varying the delay serves to mimic the acoustic characteristics of different venues such as theatres, halls, or the like. When the remote control is used to drive a pair or surround sound speakers, the electronic device is not automatically muted.

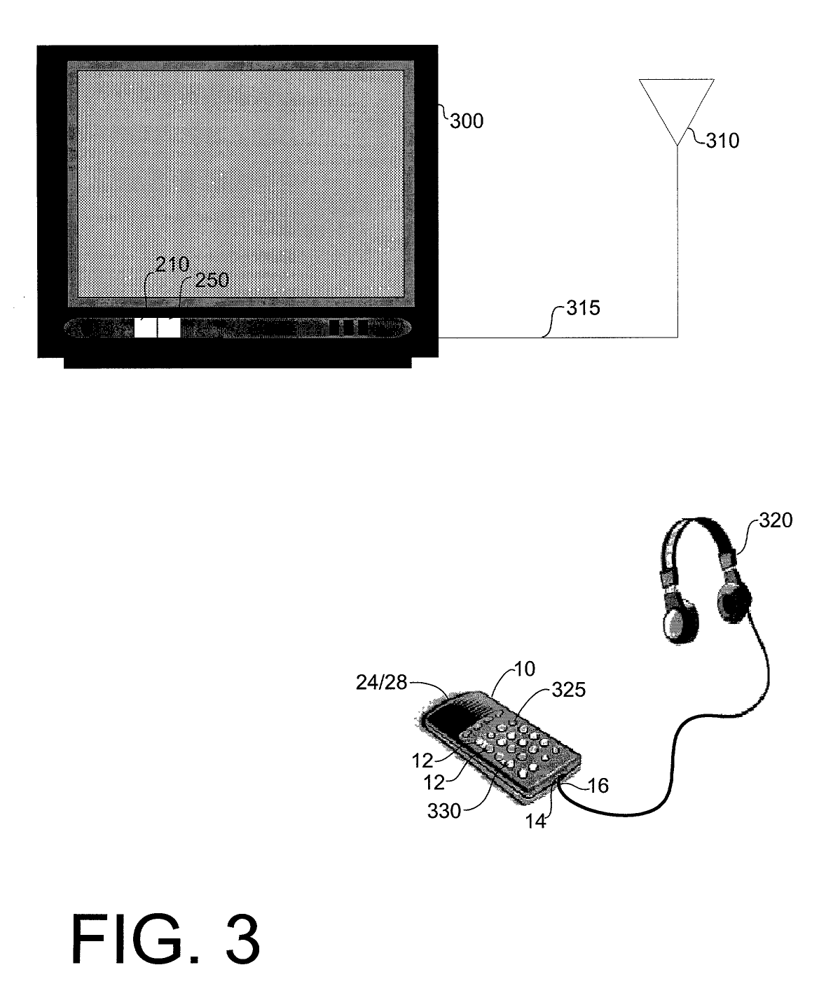

FIG. 3 is an embodiment of a system having a remote control capable of providing an audio output and an electronic device capable of transmitting a signal containing an audio component to a remote control. As shown in FIG. 3, electronic device 300 is a television, although any electronic device can be used. Television 300 receives an input from antenna 310. This input contains both an audio and video component. Additionally, the input signal 315 can be from cable television, satellite television, broadcast television, streaming video, or the like. Television 300 has a built-in receiver 210 and transmitter 250. In one embodiment, a single component is capable of performing both the transmit and receive functions. Remote control 10 is used to control television 300. In one embodiment, transmitter 250 is an add-on device, which is inserted into the headphone jack or audio output jack of television 300. Remote control 10 has a receiver 28 and a transmitter 24. In one embodiment a single component is capable of performing both the receive and transmit functions.

Remote control 10 has buttons 12 or other inputs, which control the volume of television 300. When the jack 16 of the headphones 320 is inserted into the port 14, remote control 10 preferably automatically transmits a signal to mute the television 300. Likewise, when the jack 16 is removed from the port 14, remote control 10 preferably transmits a signal to unmute the television 300. Additionally, in one embodiment, once a jack 16 (FIGS. 1A and 1B) is inserted into port 14, the audio controls i.e., mute 325 and volume 12, control the headphones 320. Once the television 300 is muted, to unmute the television 300 and return the audio control features of the remote control to controlling the television 300, the mute control 325 is activated. In one embodiment, an amplified audio signal is listened to using the headphones 320 while the electronic device 300 in an unmuted mode, thereby permitting a hearing impaired user to increase the headphone volume without increasing the electronic device volume. In one embodiment, activating the delay adjustments 330, to vary the audio delay, causes remote control 10 to transmit a signal to unmute the television 300, thereby reactivating the television's sound when surround sound speakers are used in place of headphones 320.

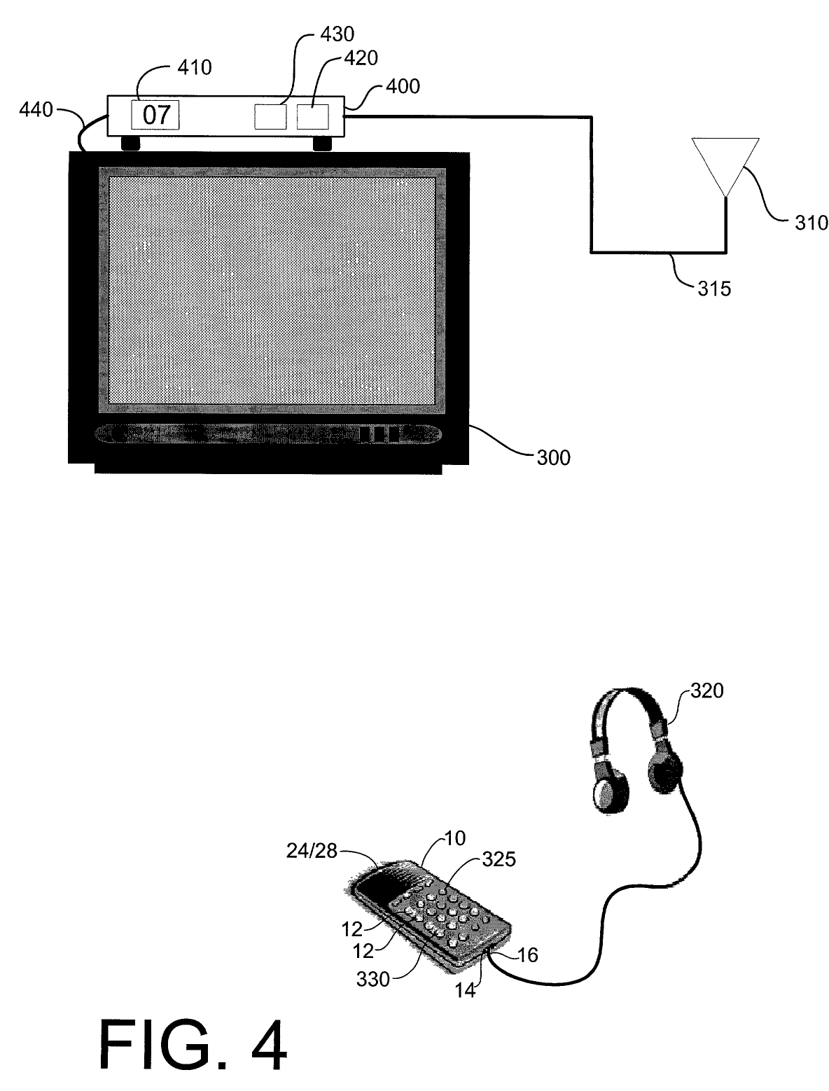

FIG. 4 is another embodiment of a system with a remote control capable of providing an audio output. The remote control 10 functions as discussed above. Device 400 is used to control television 300. Device 400 is a device such as a set-top box, a cable television converter or, in a simpler form, a device that transmits an audio signal to the remote control 10. In one embodiment, device 400 has a display 410, which displays the current selected channel. Additional displays may be present to visually alert the user when the device is in the mute mode. Device 400 contains a transmitter 430 and receiver 420. The transmitter 430 and receiver 420 function as described above with reference to transmitter 250 and receiver 210. When device 400 receives a mute command from remote control 10, the audio component is removed from the signal 440 fed to television 300. Upon receiving a subsequent mute command, the audio component of the signal 440 fed to the television is restored. In one embodiment, transmitter 430 and receiver 420 are one component. Further, in one embodiment device 400 is a standalone unit, containing transmitter 430 and its related circuitry. Device 400 receives its input from an antenna, a cable television line, an audio output port on electronic device 300, or the like.

In one embodiment, when the remote control is driving a pair of surround sound speakers, the delay is controlled by the remote control using buttons 330. The delay is then added to the audio signal transmitted by device 400. The audio signal decoded by the remote control is delayed and no further delay is required to create the surround sound effect. In another embodiment, the delay is added to the audio signal by the remote control 10.

To conserve power, the remote control preferably remains in a stand-by mode when it is not being used. In this manner, power is used when a command is transmitted to the electronic device. Preferably, the audio output circuitry (30, 32, 34 FIG. 2) is not powered until a jack 16 is inserted into port 14. In one embodiment, a signal is transmitted on control line 40 from audio output 36 when a jack 16 is inserted into port 14. Control line 38 then directs the powering of the required circuits. In one embodiment, inserting a jack 16 into port 14 simultaneously powers the output circuitry and transmits a muting signal to the electronic device being controlled.

Although the present invention was discussed in terms of certain preferred embodiments, the invention is not limited to such embodiments. Rather, the invention includes other embodiments including those apparent to a person of ordinary skill in the art. Thus, the scope of the invention should not be limited by the preceding description but should be ascertained by reference to the claims that follow.

What is claimed is:

1. A remote control for controlling an electronic device, said electronic device responsive to commands, having an audio output, comprising:
(a) a set of input controls adapted to accept said commands;
(b) a transmitter adapted to transmit said commands to said electronic device;
(c) a receiver adapted to receive an audio signal from said electronic device, said receiver generating an audio output;
(d) a port coupled to said receiver, said port adapted to receiving a jack; and
(e) circuitry adapted to feed said audio output to said port.

2. The remote control of claim 1 further compromising circuitry to transmit a mute command to said electronic device when a jack is received in said port.

3. The remote control of claim 2 wherein said input controls include a volume level control for said electronic device, said volume level control further being configured to control a volume level of said the audio output.

4. The transmitter of claim 1 wherein said transmitter is an infra-red (IR) transmitter.

5. The transmitter of claim 1 wherein said transmitter is a wireless radio frequency transmitter.

6. The receiver of claim 1 wherein said receiver is an infra-red (IR) receiver.

7. The receiver of claim 1 wherein said receiver is a wireless radio frequency receiver.

8. A remote control capable of wireless control of an electronic device, said remote control comprising:
a detector, said detector adapted to detect a modulated signal transmitted from said electronic device;
a demodulator, said detector connected to said demodulator, said demodulator demodulating said modulated signal;
a digital to analog converter connected to said demodulator;
an amplifier connected to said demodulator, said digital to analog converter and said amplifier producing an audio output in response to said demodulated signal from said demodulator.

9. The remote control of claim 8 further compromising: a plug adapted to receive a jack; and circuitry adapted to feed said audio output to said plug adapted to receive a jack.

10. The remote control of claim 9 further compromising circuitry adapted to transmit a signal capable of muting said electronic device when said plug adapted to receive a jack receives a jack.

11. The remote control of claim 9 further compromising circuitry adapted to apply power to said amplifier when said plug receives a jack.

12. A remote control capable of wireless control of an electronic device transmitting a modulated audio signal, said remote control comprising: a detector adapted to detect said modulated audio signal transmitted from said electronic device; a demodulator coupled to said detector, said demodulator demodulating said signal; a digital to analog converter coupled to said demodulator, said digital to analog converter producing an audio output; input means for entering commands to control said electronic device, said commands including volume level control, said volume level control controlling said electronic device and said audio output of the remote control; and an audio output port, said audio output port adapted to receive a jack.

13. The remote control of claim 12 wherein said demodulator and said digital to analog converter are powered when a jack is received in said port.

14. The remote control of claim 12 further comprising circuitry to add a delay to said audio output.

15. A system comprising:
an electronic device;
a remote control, said remote control capable of wirelessly controlling said electronic device and adapted to provide an audio output, said remote control having a detector, said detector for detecting a modulated signal transmitted from said electronic device, said detector connected to a demodulator, said demodulator demodulating said signal, said remote control further having a digital to analog converter connected to said demodulator, said digital to analog converter producing an audio output, said audio output fed to an audio output port, said audio output port adapted to receive a headphone jack, said remote control adapted to transmit a command to said electronic device when a headphone jack is received in said audio output port, said command muting said electronic device, and said electronic device capable of transmitting a signal containing an audio component to said remote control, said electronic device configured to receive commands from said remote control, said commands including a command to mute said electronic device, said electronic device having an analog to digital converter, said analog to digital converter for converting an analog audio signal into a digital audio signal, said analog to digital converter connected to a modulator for modulating the digital audio signal output of said analog to digital converter to create a modulated signal, said modulator connected to a transmitter, said transmitter for transmitting said modulated signal to said remote control.

16. A remote control for controlling an electronic device having an audio output, comprising:
(a) means for inputting commands for controlling said electronic device having an audio output;
(b) means for transmitting said commands to said electronic device;
(c) means for receiving an audio signal from said electronic device and generating an audio output;
(d) means for receiving a jack, said means for receiving a jack coupled to said means for receiving and audio signal, said means for receiving a further adapted to feed said audio output is fed to said jack; and
(e) a means for transmitting a mute command to said electronic device when a jack is received in said means for receiving a jack.
